(19) United States
(12) Patent Application Publication
(10) Pub. No.: US 2008/0080372 A1
(43) Pub. Date: Apr. 3, 2008

(54) Policy management based routing and filtering of charging data records in an Internet Protocol Multimedia Subsystem

(76) Inventors: Yigang Cai, Naperville, IL (US); Yu Dong Li, Beijing (CN); Chun Guang Xu, Beijing (CN)

Correspondence Address: HARNESS, DICKEY & PIERCE, P.L.C., P.O. BOX 8910, RESTON, VA, 20195, US

(21) Appl. No.: 11/529,306

(22) Filed: Sep. 29, 2006

(51) Int. Cl. H04L 12/26

(52) U.S. Cl. 370/230

(57) ABSTRACT

A system and method for policy management based routing and filtering of charging data records (CDRs) used to bill for services provided by an Internet Protocol Multimedia Subsystem (IMS). The system includes a Vortex Rule Engine (VRE), which includes handling instructions for routing CDRs, and a CDR routing unit. The CDR routing unit receives a CDR, sends a query to the VRE for handling instructions relating to the received CDR, and routes the CDR based on the handling instructions received from the VRE in response to the query. The method includes the steps of receiving a CDR from a charging data function (CDF), sending a query relating to the CDR to a vortex rule engine (VRE), and routing the CDR to a storage location based on instructions received from the VRE.

### BACKGROUND OF INVENTION

1. Field of the Invention

The present invention is related to a system and method for telecommunications. More particularly, the present invention relates to policy management based routing and filtering of charging data records (CDRs) used to bill for services provided by an Internet Protocol Multimedia Subsystem (IMS).

2. Background Information

3GPP Release 6 standards define an offline charging architecture to provide billing services related to use of an IMS network.

Referring to FIG. 1, the offline charging architecture includes a Charging Trigger Function (CTF) 610, a Charging Data Function (CDF) 620, a Charging Gateway Function (CGF) 630 and a Billing Domain (BD) 640. One skilled in the art will appreciate that the BD 640 may also be a billing system and/or a billing mediation device.

The CTF 610 generates charging events by monitoring network resource usage. The CTF 610 receives information from various service elements such as service element 605 shown in FIG. 1. The information received from service element 605 includes, but is not limited to, charging information relating to the services provided by the service element 605. The CTF 610 is the focal point for collecting the charging information pertaining to chargeable events within the service element 605, assembling this charging information into charging events, and sending these charging events to the CDF 620. One skilled in the art will readily appreciate that the CTF 610 generally includes an accounting metrics collection function and an accounting data forwarding function, which are well-known in the art.

The CDF 620 receives the charging events from the CTF 610 via the Rf interface. The CDF 620 uses the information contained in the charging events to construct Charging Data Records (CDRs). The CDF 620 then transfers the CDRs to at least one CGF 630 via the interface Ga.

The CGF 630 acts as a gateway between the IMS network 600 and the BD 640. The CGF 630 uses the interface Bx to transfer the CDRs to the BD 640. The CGF 630 performs the following main functions: CDR pre-processing; CDR routing and filtering; and CDR file management. The CDR pre-processing includes validating, consolidating, formatting and re-formatting CDRs; CDR error handling; and persistent CDR storage. The CDR routing and filtering involves storing CDRs in separate files based on filtering criteria such as a CDR type, CDR parameters and an originating CDF. CDR File Management includes creating files, opening files, triggering the opening and closing of files and deleting files.

The concept of CDR routing and filtering based on filtering criteria is presented in 3GPP specification 32.240. However, the implementation architecture and mechanism is not described in detail in the 3GPP specification 32.240.

Currently, there is no deployed CGF, which supports CDR routing and filtering. Further, the complexity of CDR types and usages would likely result in a conventional filtering and routing mechanism being prohibitively expensive. Still further, the mechanism of filtering and routing the CDR files requires flexibility and accuracy.

Policy Management is increasingly important in the management of telecommunications networks to provide high flexibility in determining how resources are deployed and what services can be provided. Much of the existing support for policy in networks has been driven by the need for relatively simple policies that can be enforced in high volume and ultra-short response times. However, as networks converge and end-user services become increasingly rich, it is important to provide a richer policy infrastructure, so that operators and end-users can easily customize and personalize end-user access to, and experience of, converged services.

Standards bodies (IETF, ETSI and 3GPP) have defined policy management requirements for Open Service Access (OSA) since 2002. A policy management engine was developed in 1999 and patented in U.S. Pat. Nos. 6,424,948 and 6,499,023. The entire contents of U.S. Pat. Nos. 6,424,948 and 6,499,023 are herein incorporated by reference. Further, the “Declarative Workflow System Supporting Side-Effects” and the “Data Item Evaluation Based on the Combination of Multiple Factors” described in U.S. Pat. Nos. 6,424,948 and 6,499,023 are referred to herein as a Vortex Rule Engine (VRE).

### SUMMARY OF THE INVENTION

An example embodiment of the present invention provides a method of routing a CDR in an IMS. The method includes the steps of receiving a CDR from a CDF; sending a query relating to the CDR to a VRE; and routing the CDR to a storage location based on instructions received from the VRE.

Another example embodiment of the present invention provides a system for routing a CDR in an IMS. The system includes a VRE including handling instructions for routing CDRs; and a CDR routing unit receiving a CDR, sending a query to the VRE for handling instructions relating to the received CDR, and routing the CDR based on the handling instructions received from the VRE in response to the query.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is an example offline charging architecture as provided by the 3GPP Release 6 standards;

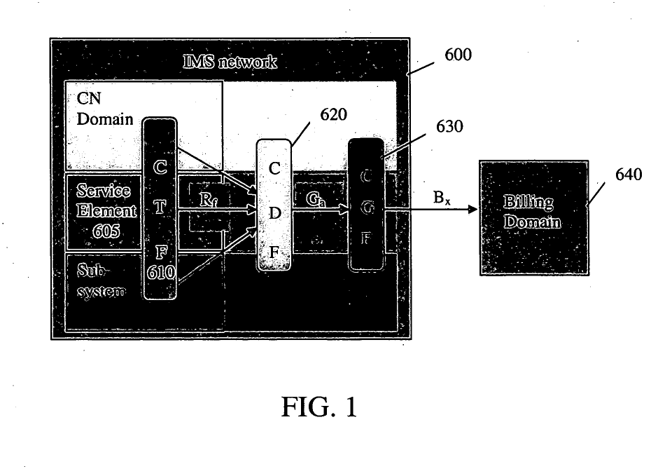

FIG. 2 illustrates an example system providing policy management based routing and filtering of charging data records (CDRs) used to bill for services provided by an IMS according to an example embodiment of the present invention;

FIG. 3 is a block diagram of an example data structure according to an example embodiment of the present invention; and

FIG. 4 is a flow chart illustrating a method for filtering and routing a CDR according to an example embodiment of the present invention.

### DETAILED DESCRIPTION OF EXAMPLE EMBODIMENTS

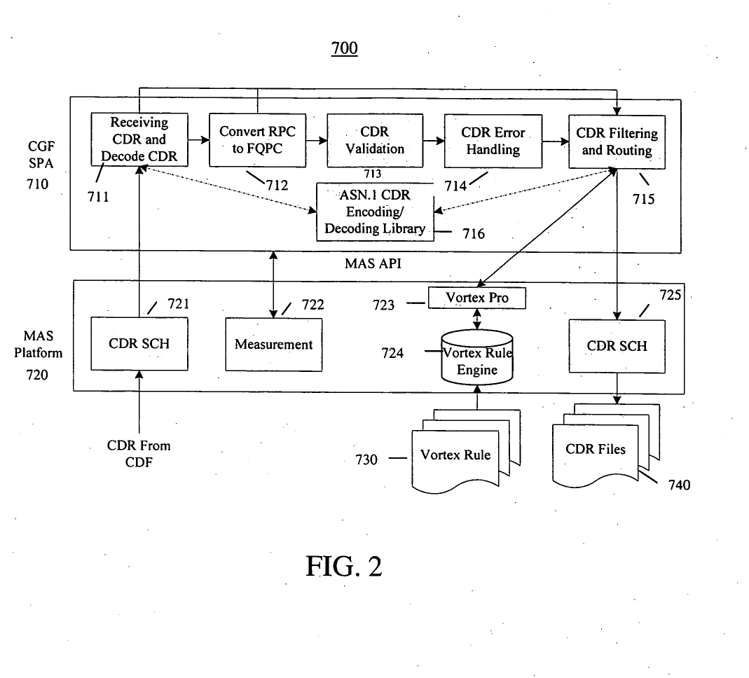

FIG. 2 illustrates an example system 700 providing policy management based routing and filtering of charging data records (CDRs) used to bill for services provided by an Internet Protocol Multimedia Subsystem (IMS). The system 700 includes a CGF service 710 and a platform 720.

The platform 720 includes the following: an incoming CDR Signaling Control Handler (CDR SCH) unit 721; a Measurement unit 722; a VRE 724; and an outgoing CDR SCH unit 725. The incoming CDR SCH unit 721 receives CDRs from a CDF, and the outgoing CDR SCH unit 725 outputs CDR files 740 to a billing domain. The VRE 724 creates, edits and maintains the policy rules implemented in the VRE.

The VRE 724 provides fast, scalable, carrier-grade support for specifying and executing policies that are expressive enough to support applications requiring richer policy management in order to manage resources effectively and take advantage of increased flexibility. The VRE 724 is used to influence service functionality, outside of the usual controls of protocol messages and provisioned data, by allowing the logic of the VRE to be specifically customized by service providers and eventually end users, who may input vortex rules 730. The VRE 724 uses a set of pre-selected and hard-coded Decision Points (DPs) to influence service functionality.

The VRE 724 described above is used in conjunction with the CDR filtering and routing unit 715 of the CGF service 710 to route and filter CDRs according to example embodiments of the present invention, which will be described in greater detail below.

The CGF service 710 includes the following: a receiving CDR and decoding CDR unit 711; a conversion unit 712; a CDR validation unit 713; a CDR Error Handling unit 714; a CDR filtering and routing unit 715; and an ASN.1 CDR Encoding/Decoding Library 716.

This application is directed towards the filtering and routing CDRs and thus, the remaining components of the CGF service 710, which are not directly related to the filtering and routing of CDRs, will not be discussed herein for the sake of brevity. As such, the remainder of this specification is primarily focused on the functions of the CDR filtering and routing unit 715 and communications between the CDR filtering and routing unit 715 and the VRE 724 of the platform 720.

The CGF service 710 communicates with the VRE 724 to support a set of Name/Value Pairs (NVP's) used by the VRE 724. The CGF service 710 also receives a set of NVPs communicated from the VRE 724 to the CDR filtering and routing unit 715 in response to a query from the CDR filtering and routing unit 715. The CGF service 710 also communicates with the VRE 724 to enable a response to a query, which may cause the CGF service 710 to invoke one or more actions. The actions supported include: executing an action such as sending an alarm, firing a log file, pegging a measurement, etc., as well as executing a Decision Graph (DG). The actions are well-known in the art and will not be discussed herein for the sake of brevity.

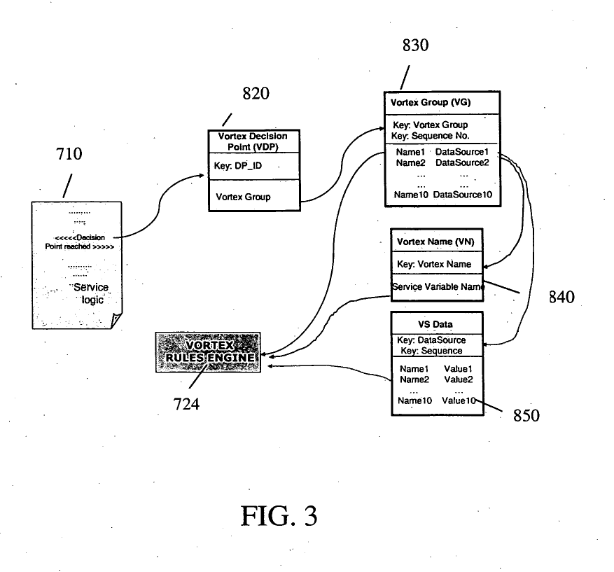

FIG. 3 demonstrates an example data structure CDR filtering and routing unit 715 of the CGF service 710. FIG. 3 shows the CGF service 710, a Vortex Decision Point (VDP) 820, a Vortex Group (VG) 830, a Vortex Name (VN) 840; Vortex Specific (VS) data 850 and the VRE 724. The VDP 820 activates individual DPs and associates DPs with VGs 830. The VGs 830 associate input information with a DP and specify the pre-defined VN 840. Some service variables are allocated pre-defined VNs 840 so that the VRE 860 can directly use the VNs 840. VNs 840 are associated with service variables. The VS data is used to assign specific values to VNs 840. In other words, the VDP 820 enables/disables the VDP 820 where a policy rule shall be invoked, and VGs 830, VNs 840 and VS 850 are used to flexibly associate service logic 810 information with the vortex rules 730 implemented in the VRE 724.

According to an example embodiment of the present invention, customized policies are utilized for CDR filtering and routing.

In particular, before the CDR filtering and routing unit 715 of the CGF service 710 routes a CDR to be recorded onto a disk, the CDR filtering and routing unit 715 provides corresponding information such as CDR type, CDR parameters, originating CDF, etc. in a query to the VRE 724. A CDR Type indicates an IMS node for which a CDR record is being generated. Examples of different IMS nodes include a S-CSCF, MGCF, etc. The CDR parameters may be used for the CDR routing and filtering. Example CDR parameters are Role of Node, ICID, Calling Party Address, etc. The VRE 724 may determine the CDR file extension and directory based on the corresponding information. Therefore, the CDR filtering and routing unit 715 can route the CDR into a file with the specified file extension into a specified directory. The information provided to VRE 724 can be customized easily because of the flexible data structure described above and the policy can be updated and/or upgraded at the VRE 724 engine with relatively no impact on the CGF service 700.

VRE input for filtering criteria, which are provided by the CDR filtering and routing unit 715 and input to the VRE 724, may include CDR type, node of address, application server information, call direction, call type, service type, service mode, etc. The CDR generated and processed by the CDF and the CGF will be classified and stored in subdirectories based on the filtering and routing rule execution. This results in a different CDR file name and extension based on rule criteria.

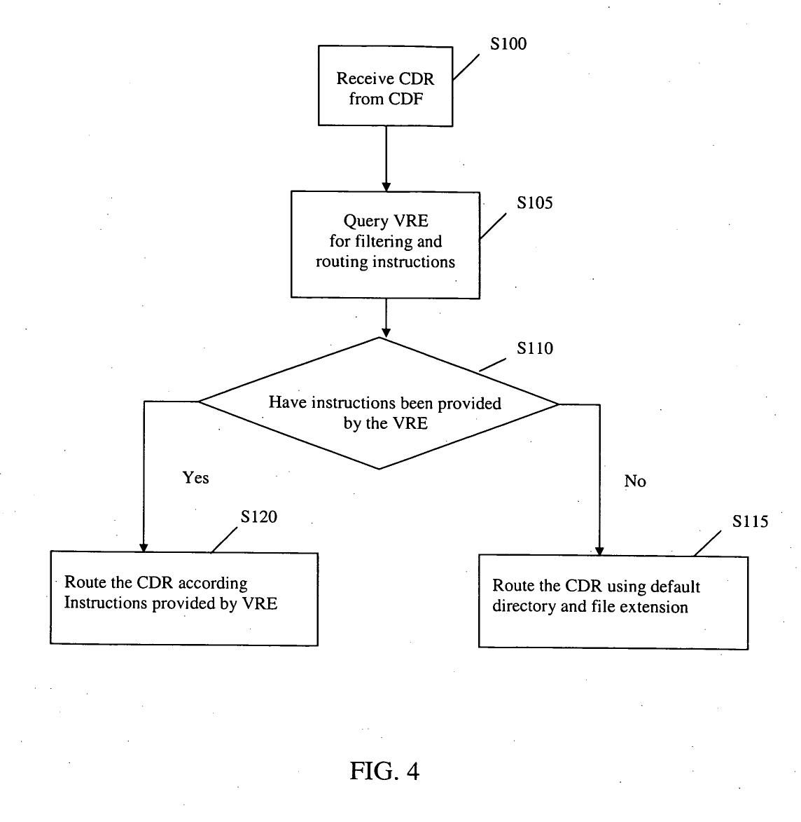

FIG. 4 is a flow chart illustrating a method for filtering and routing a CDR according to an example embodiment of the present invention, which is performed by the CDR filtering and routing unit 715.

In step S100, the CDR filtering and routing unit 715 receives a CDR from a CDF. The CDR includes a variety of information, which may be provided by the CDF. For example, if the CDR is related to hotel telephone call records, the information may include the hotel name, location, and room number.

In response to receiving a CDR from the CDF, the CDR filtering and routing unit 715 queries the VRE 724 for filtering and routing instructions in step S105. The query transfers CDR information to the VRE 724. For example, the query may include the hotel name, location and room number for a CDR related to a telephone call made by a guest of the hotel.

The VRE 724 may provide filtering and routing instructions to the CDR filtering and routing unit 715 in response to the query. For example, the VRE 724 may instruct the CDR filtering and routing unit 715 to store the CDR in a storage location that is set aside for telephone calls for the room number of the hotel. The instructions provided by VRE 724 are based on policies implemented in the VRE 724, which may be based on the vortex rules 730.

After the query is sent to the VRE 724, the CDR filtering and routing unit 715 determines if instructions have been provided by the VRE 724 in step S110. If instructions have been provided by the VRE 724, the CDR filtering and routing unit 715 filters and routes the CDR based on those instruction in step S120. For example, if the VRE 724 has provided a directory and file extension used for hotel telephone calls from the room number included in the query, the CDR filtering and routing unit 715 will route the CDR to that directory and save the CDR file using the provided file extension. Alternatively, if instructions have not been provided by the VRE 724 in response to the query for the CDR, the CDR filtering and routing unit 715 will filter and route the CDR in a default manner. For example, the CDR filtering and routing unit 715 will route the CDR to a default directory and save the CDR file using a default file extension.

As previously described, policies implemented by the VRE 724 may be easily customized by service providers and/or end users. For example the service providers and/or end users may modify the policies by supplying new or modified vortex rules 730 to the VRE 724.

An example of a vortex rule 730 provided to the VRE 724 of the CGF service is illustrated below. The notation of each rule section is imbedded to give detailed instruction. This example rule demonstrates that one CDR record is routed to a specific directory with specific file extension according to Record Type, Node Address and Application Service Information.

Ruleset: VTX_CDR_Filtering_Routing// The name of a Vortex rule

| | |
|---|---|
| Domain: CGF; | // Domain should be application |
| name | |
| rulegroup: CDR_Filtering_Routing; | // Rulegroup names should |

reflect Decision Point that calls this rulegroup
// Variable definition
variables:

| | |
|---|---|
| record_type: string; | // CDR Record Type includes S- |

CSCF, P-CSCF, I-CSCF, MRFC, MGCF,

| | |
|---|---|
| | // BGCF and AS. |
| node_address: string; | // The Node Address filed in |
| CDR record. | |
| app_server_info: string; | // The Application Server |
| information in the CDR record. | |
| file_extension: string; | // The file extension that shall |
| be used for the CDR file | |
| file_directory: string; | // The file directory that the |

CDR file shall be stored in
// I/O signature
input_variables: record_type, node_address, app_server_info;
output_variables: file_extension, file_directory;
// Rules section:

| | |
|---|---|
| rule:rule0 | // In rule0 - initialize the output |

```
parameters to _NULL or _NA
if (true)
then
  file_extension = “_NULL”;
  file_directory = “_NULL”
end
// Rule 1 specify what CDR record shall be rout into directory
“FS5000” with file extension “cscf”
rule:rule1
if( “record_type = S-CSCF” & “node_address = 135.252.18.60“ &
“app_server_info = FS5000”)
then
```

| | |
|---|---|
| file_extension = cscf; | // Rule 1 specified file extension |
| file_directory = FS5000; | // Rule 1 specified file directory |
| end | |

| | |
|---|---|
| rule:rule2 | // Subsequent rules should be ordered |
| in 2, 3 et.c | |
| if (<condition>) | |
| then | |
| <rules> | |
| end | |

In addition to the example embodiments described above, in which the CDR filtering and routing unit 715 filters and routes the CDR based on communications with the VRE 724, the VRE 724 may also instruct the CGF service 710 to cause an alarm/log file/measurement based on error conditions such as: CDR decoding failure; Reduced Partial CDR restoration failure; CDR validation failure; etc.

Example embodiments of the present invention as described above provide a flexible solution to CDR filtering and routing using policy management enabled service customization of a CGF for IMS offline charging. As such, the end user can conveniently provision filtering and routing criteria locally or remotely. With this capability, offline charging CDRs will be purposely routed to pre-defined CDR file subdirectories which can be then pulled or pushed to the Billing Mediation Device (BMD) or Billing System (BS). Then the service providers can process the CDR and generate billing invoice based on CDR categories.

Example embodiments of the present invention being thus described, it will be obvious that the same may be varied in many ways. Such variations are not to be regarded as a departure from the invention, and all such modifications are intended to be included within the scope of the invention.

What is claimed:

1. A method of routing a charging data record (CDR) in an Internet Protocol Multimedia Subsystem (IMS), comprising:
receiving a CDR from a charging data function (CDF);
sending a query relating to the CDR to a vortex rule engine (VRE); and
routing the CDR to a storage location based on instructions received from the VRE.

2. The method of claim 1, wherein the query includes at least one of a CDR type, CDR parameters and an originating CDF.

3. The method of claim 1, wherein the instructions received from the VRE identify a storage location and file extension.

4. The method of claim 3, wherein the routing step routes the CDR to the storage location.

5. The method of claim 3, further comprising:
storing the CDR having the file extension in the storage location.

6. The method of claim 1, further comprising:
routing the CDR to a default storage location if no instructions are received from the VRE in response to the query.

7. A system for routing a charging data record (CDR) in an Internet Protocol Multimedia Subsystem (IMS), comprising:
a VRE including handling instructions for routing CDRs; and
a CDR routing unit receiving a CDR, sending a query to the VRE for handling instructions relating to the received CDR, and routing the CDR based on the handling instructions received from the VRE in response to the query.

8. The system of claim 7, wherein the query includes at least one of a CDR type, CDR parameters and an originating CDR.

9. The system of claim 7, wherein the handling instructions relating to the received CDR identify a storage location for storing the received CDR and a file extension used to store the received CDR.
